(19) United States
(12) Patent Application Publication
(10) Pub. No.: US 2014/0033596 A1
(43) Pub. Date: Feb. 6, 2014

(54) AUTOMATED MIGRATORY BIRD ABATEMENT UNIT

(71) Applicant: Jeffrey Joseph Schukow, Sheboygan, WI (US)

(72) Inventor: Jeffrey Joseph Schukow, Sheboygan, WI (US)

(21) Appl. No.: 13/563,671

(22) Filed: Jul. 31, 2012

(51) Int. Cl. A01M 29/06

(52) U.S. Cl. 43/2

(57) ABSTRACT

An automated bird abatement unit prevents birds from nesting in undesirable locations. The automated unit starts its cycle by shocking any nearby birds with the decoy flying out of a nest. A sound system also cycles at startup. The decoy then flies back to its nest, at least partially concealing the decoy. In this manner, birds in the area do not end up overexposed to decoys, keeping them effective.

### BACKGROUND OF THE INVENTION

The present invention relates to bird abatement devices and methods and more particularly, to an automated migratory bird abatement unit that does not overexpose birds to decoys, keeping the unit effective.

Nesting birds on roof tops cause building degradation because of the high acid content in their droppings. The fecal matter also spreads many viruses, bacteria and parasites. Sidewalks, roadways and cars can get contaminated with the acid laden droppings, ruining paint.

Existing solutions have no shock effect on nesting birds and, often in as soon as only three days, the birds can become overexposed, where the existing solution is no longer effective. Overexposure to decoy birds, for example, results in the nesting birds simply ignoring them. The only solution is then to change the decoys or to physically move them, increasing labor costs.

As can be seen, there is a need for an improved method and device for preventing birds from nesting in undesired areas, without overexposing the birds to decoys, keeping the method and device effective.

### SUMMARY OF THE INVENTION

In one aspect of the present invention, a animal abatement system comprises a cable running from a nest pole to a snubber pole; a concealment nest disposed on the nest pole; and a decoy disposed in the concealment nest, the decoy operable to move along the cable and return to the concealment nest at predetermined times.

These and other features, aspects and advantages of the present invention will become better understood with reference to the following drawings, description and claims.

### BRIEF DESCRIPTION OF THE DRAWINGS

FIG. 1 is a side view of a bird abatement unit according to an exemplary embodiment of the present invention;

FIG. 2 is a detailed cross-sectional view of a launching device of the bird abatement unit of FIG. 1;

FIG. 3 is a side view of a bird abatement unit according to another exemplary embodiment of the present invention;

FIG. 4 is a side view of an alternate decoy that could be used with the bird abatement unit of the present invention;

FIG. 5 is a side view of a dual bird nest bird abatement unit according to an exemplary embodiment of the present invention; and

FIG. 6 is a cross sectional view taken along line 6-6 of FIG. 5, showing a pulley used in the dual bird nest bird abatement unit.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an automated unit for preventing birds from nesting in undesirable locations. The automated unit starts its cycle by shocking any nearby birds with the decoy flying out of a nest. A sound system also cycles at startup. The decoy then flies back to its nest, at least partially concealing the decoy. In this manner, birds in the area do not end up overexposed to decoys, keeping them effective.

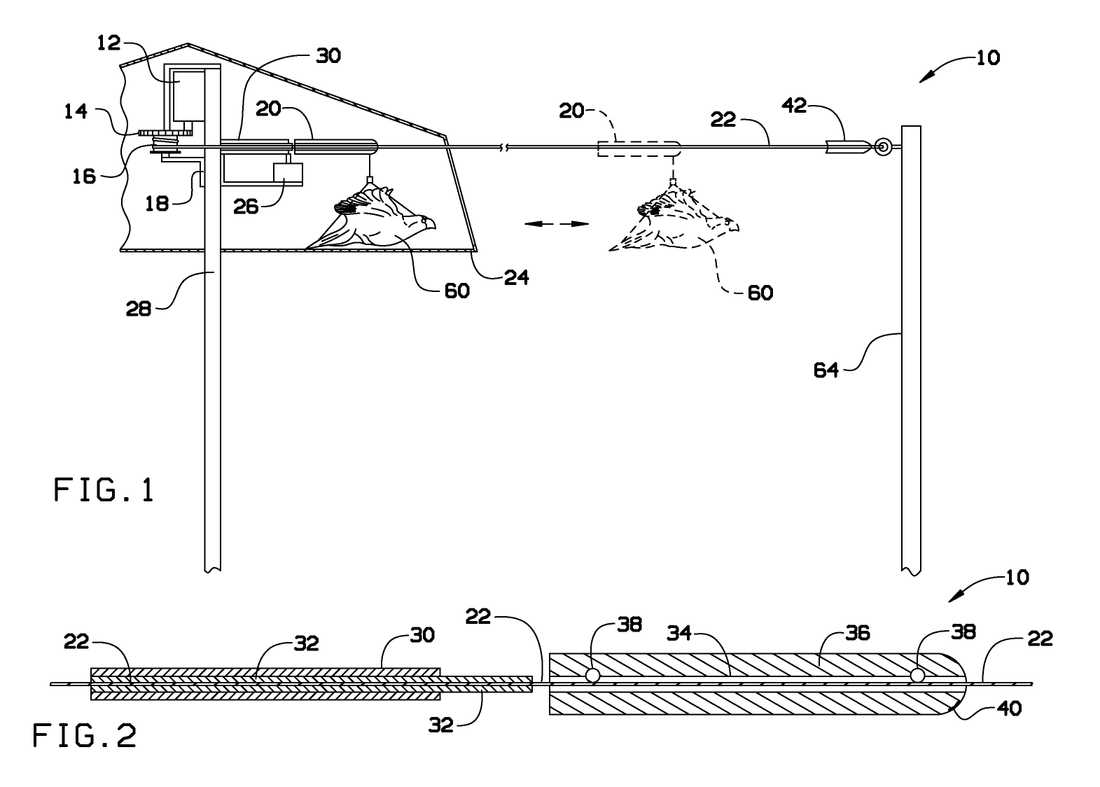

Referring to FIGS. 1 and 2, a bird abatement unit 10 includes a cable 22 extending between a nest pole 28 and a snubber pole 64. The poles 28, 64 can be variable of fixed height poles, typically attached to the ground, a building rooftop or the like. The cable 22 can be made of various materials provided that it can stay tight between the poles 28, 64. For example, the cable 22 can be a greased steel cable.

A motor 12 can be mounted on the nest pole 28. The motor 12 can turn a drive gear 14 having a retrieval spool 16. An adjustable spool drag tensioner can adjust the drag on the spool 16 to control the speed and distance a decoy 60 can travel.

The decoy 60 can be attached to a ballistic carrier weight 20. The ballistic carrier weight 20 can include an inner guide tube 34 through which the cable 22 extends. Linear bearings 38 may be disposed inside the inner guide tube 34 to help minimize friction as the ballistic carrier weight 20 travels along the cable 22. The ballistic carrier weight 20 can be made of various materials. Typically, the ballistic carrier weight 20 may be made of a heavy material, for example the ballistic carrier weight 20 can have a lead filler 36.

A launching mechanism can be disposed to propel the ballistic carrier weight 20. Various mechanisms can be used to apply a force to the ballistic carrier weight 20 to send the weight 20 and the decoy 60 out along the cable 22. For example, an inner spring guide tube 32 can be attached to the nest pole 28 with the cable 22 running therethrough, as shown in FIG. 2. An outer latch tube 34 can slide along the inner spring guide tube 32 and can be held in place with a ballistic weight launch and retrieval solenoid 26. When it is time to launch the decoy 60, the solenoid 26 can release the outer latch tube 34, which is propelled, typically by a loaded spring (not shown) disposed between the outer latch tube 34 and the nesting pole 28. The outer latch tube 34 can propel the ballistic carrier weight 20 along the cable 22.

A retrieval line (not shown) can be attached to a retrieval line attachment 40 on the ballistic carrier weight 20. After the decoy 60 is launched, the motor 12 can turn the retrieval spool 16 to cause the decoy 60 and the ballistic carrier weight 20 to return to the concealment nest 24. The adjustable spool drag tensioner 18 can control the drag of the ballistic carrier weight 20 along the cable 22 so that, when the ballistic carrier weight 20 reaches a ballistic carrier weight snubber 42 at an opposite end of the cable 22, it does not strike the snubber 42 at a high velocity.

In some embodiments, the cable 22 may be placed horizontally, as shown generally in FIG. 1. In some embodiments 22, the cable may be placed such that the snubber pole 64 is higher than the nesting pole 28. This can allow the decoy 60 and the ballistic carrier weight 20 to slide back to the concealment nest 24 under the force of gravity.

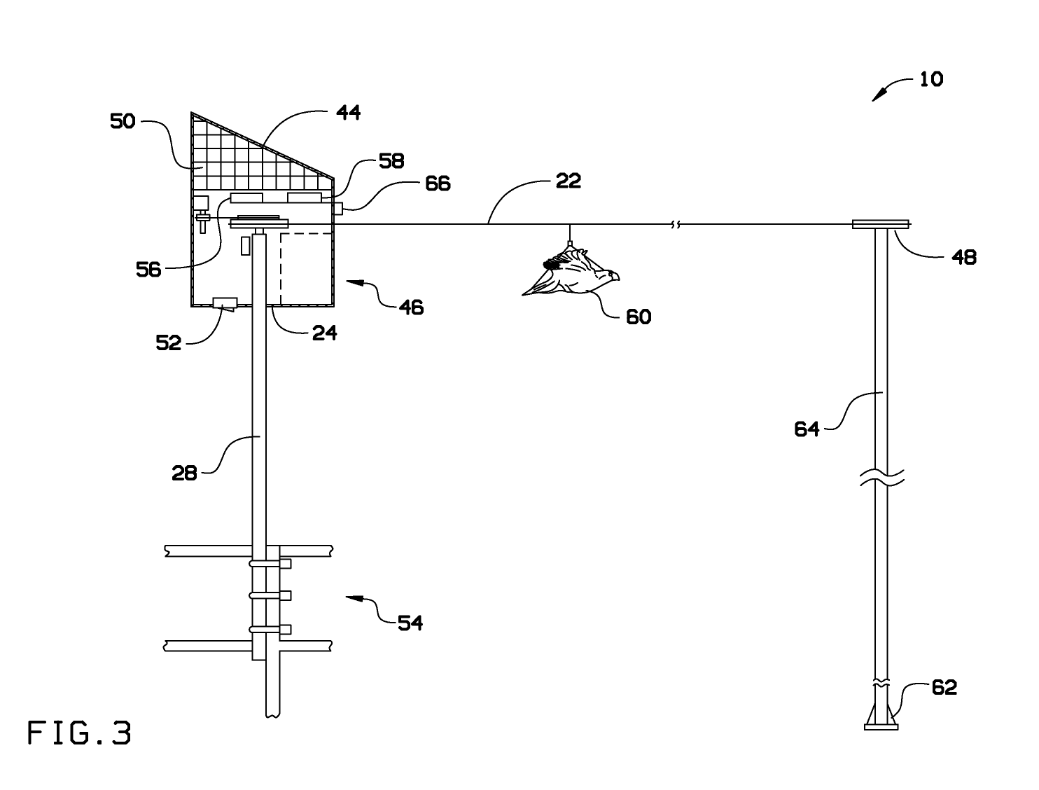

Referring to FIG. 3, a solar panel 44 can be provided on the concealment nest 24 to provide power to the motor. Charge/control circuitry 56 can be used in conjunction with the solar panel 44 and one or more batteries 58. An exclusion screening 50 can be disposed over the concealment nest 24 as needed. An arming switch 52 can be disposed to turn the system on and off. A light sensor 66 can be used to prevent operation of the system after dark when the use of such a system may be ineffective. In some embodiments, the light sensor 66 can be used to detect motion, such as an unwanted nesting bird, where such motion can activate a cycle of the bird abatement unit.

The nesting pole 28 and/or the snubber pole 64 can be attached to various surfaces, as described above. A railing U-bolt mount 54 can be used to attach one pole 28, 64 (such as nesting pole 28 as shown in FIG. 3) to a railing. A base-plate mount 62 can be used to attach one pole 28, 64 (such as snubber pole 64 as shown in FIG. 3) to a solid surface, such as a roof deck.

In FIG. 3, the decoy 60 can be attached to the cable 22 and the cable can extend about a pulley 48 on the snubber pole 64. In this embodiment, the cable 22 can move about a continuous path, causing the decoy 60 to move from and back to the concealment nest 24. A concealment opening 46 on the concealment nest 24 can provide a path for the decoy 60 to enter and exit.

Referring now to FIGS. 5 and 6, a bird abatement unit can include a concealment next that houses two decoys 60. The decoys 60 can fly from the concealment nest to first and second pipe supports 68 and back. The decoys 60 can be attached to two cables, one running to the first pipe support 68 and another running to the second pipe support 68. The cables 22 can be connected, via line spool 74, to a line tensioning canister weight 70. The line spool 74 can act provide a mechanical advantage due to the side difference between pulley 48 and line spool 74. The line spool 74 and pulley 48 may be disposed on a shaft 76.

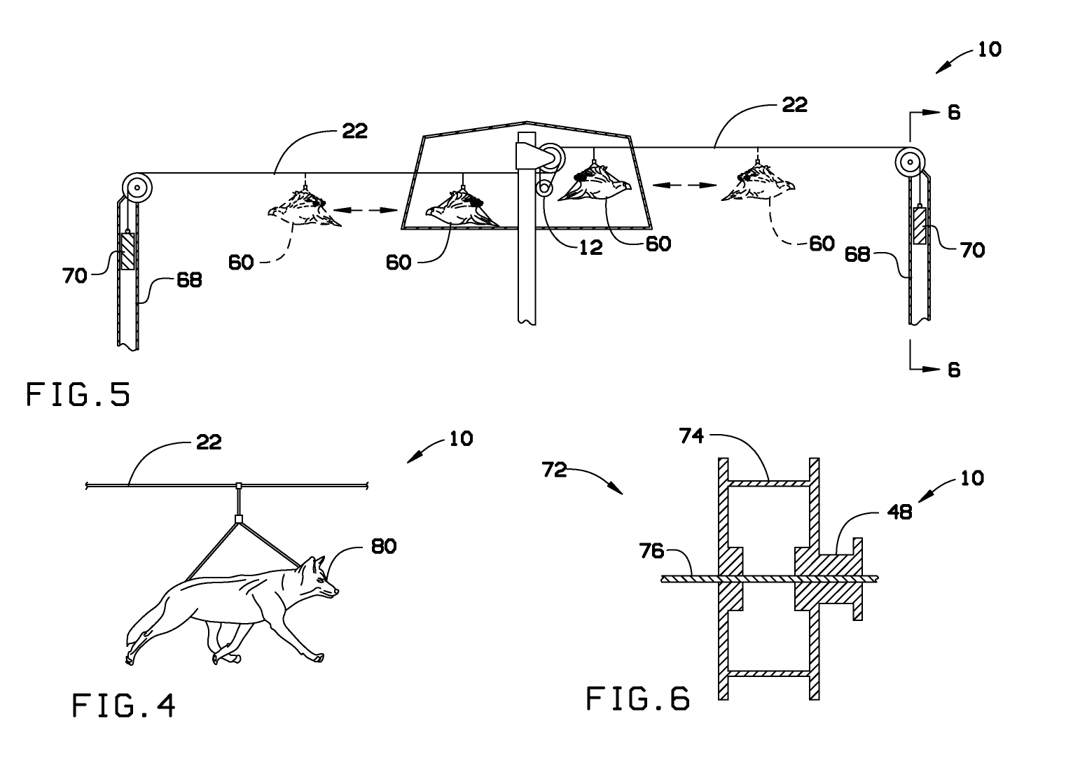

Referring to FIG. 4, the decoy 60 can be replaced, in place of a falcon or similar bird, with another shape, such as that of a wolf 80, for example. Other shapes for the decoy can be used depending on the intended application. With land-based animals being used in the unit of the present invention, the cable 22 may run closer to the ground.

It should be understood, of course, that the foregoing relates to exemplary embodiments of the invention and that modifications may be made without departing from the spirit and scope of the invention as set forth in the following claims.

What is claimed is:

1. An animal abatement system comprising:
a cable running from a nest pole to a snubber pole;
a concealment nest disposed on the nest pole; and
a decoy disposed in the concealment nest, the decoy operable to move along the cable and return to the concealment nest at predetermined times.

2. The animal abatement system of claim 1, further comprising a ballistic carrier weight adapted to slide along the cable.

3. The animal abatement system of claim 2, further comprising a launching mechanism operable to propel the ballistic carrier weight along the cable.

4. The animal abatement system of claim 3, further comprising a retrieval spool operable to turn to retrieve the decoy and pull the decoy back to the concealment nest.

5. The animal abatement system of claim 3, further comprising a ballistic weight launch and retrieval solenoid operable to control the launching mechanism.

6. The animal abatement system of claim 4, further comprising an adjustable spool drag tensioner operable to provide an adjustable drag on the retrieval spool.

7. The animal abatement system of claim 4, further comprising a motor operable to turn the retrieval spool.

8. The animal abatement system of claim 7, further comprising a solar panel providing power to the motor.

9. The animal abatement system of claim 1, further comprising a ballistic carrier snubber disposed at an end of the cable adjacent the snubber pole.

10. The animal abatement system of claim 1, further comprising a light sensor to control the operation of the system during certain times of the day.

11. The animal abatement system of claim 1, further comprising an arming switch disposed on the concealment nest, the arming switch operable to control the system.

12. The animal abatement system of claim 1, further comprising a railing U-bolt mount operable to retain at least one of the nesting pole and the snubber pole.

13. The animal abatement system of claim 1, further comprising a base-plate mount operable to retain at least one of the nesting pole and the snubber pole.

14. The animal abatement system of claim 1, further comprising a pulley disposed on the snubber pole, the pulley turning the cable back to the concealment nest.

15. The animal abatement system of claim 1, further comprising a first cable extending from the nesting pole toward a first pipe support; and a second cable extending from the nesting pole toward a second pipe support, the first cable and the second cable operable to carry a first decoy and a second decoy thereupon.

16. The animal abatement system of claim 15, further comprising a line tensioning canister weight disposed inside the first and second pipe supports, secured to the first and second cables.

17. The animal abatement system of claim 1, wherein the decoy is a bird.

18. The animal abatement system of claim 1, wherein the decoy is a coyote.
